(19) United States
(12) Patent Application Publication
(10) Pub. No.: US 2023/0259376 A1
(43) Pub. Date: Aug. 17, 2023

(54) Gate Operator with Context Sensitive QR Code

(71) Applicant: Intelligent Entry Machines LLC, Irvine, CA (US)

(72) Inventors: Walter Parsadayan, Newport Coast, CA (US); Peter Parsadayan, Newport Coast, CA (US); Andrew Parsadayan, Newport Coast, CA (US)

(73) Assignee: Intelligent Entry Machines LLC, Irvine, CA (US)

(21) Appl. No.: 18/164,423

(22) Filed: Feb. 3, 2023

Related U.S. Application Data
(60) Provisional application No. 63/306,761, filed on Feb. 4, 2022.

(51) Int. Cl. G06F 9/451; G06F 16/332; G06F 16/38; G06F 16/383

(52) U.S. Cl. CPC G06F 9/453; G06F 16/3329; G06F 16/381; G06F 16/383

(57) ABSTRACT

A controller for a barrier operator is provided. The controller includes a control board communicatively coupled to a device and a display communicatively coupled to the control board. The controller further includes one or more data processors configured to receive device data of the device, generate natural-language content and encoded content in response to the device data, and display the natural-language content and the encoded content on the display. A system including the controller and a handheld device is also provided. The handheld device includes a camera and a handheld display. The handheld device further includes one or more data processors configured to receive the encoded content utilizing the camera, retrieve remote informational content from a remote database based on the encoded content, and display the remote informational content on the handheld display.

This application claims priority tour co-pending U.S. provisional patent application with the Ser. No. 63/306,761, which was filed Feb. 4, 2022, and which is incorporated by reference herein.

### FIELD OF THE INVENTION

The field of the invention is systems, controllers, and methods for improving the displaying of content for a controller for a barrier operator.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Movable gates or barriers to control or restrict access to residential or commercial properties are well known in the art and depending on the particular location and need, will move the gate or barrier in a horizontal or vertical motion, or swing or pivot a gate or barrier about a point of rotation. Most commonly, the gates or barriers are communicatively coupled to a controller spaced from the gate or barrier that provides operational control and status for the gate or barrier, and the gate or barrier is moved by an operator that is controlled via a remote signal coming from the controller. In addition, the controller is also operationally coupled with one or more additional devices such as a lock, a camera, a traffic light, a sensor, etc.

In most instances, the controller includes a variety of buttons associated with function or operation of each of the devices or with functionality of the controller. Moreover, some controllers also include a display that provides basic status and operating information of the devices and the controller based on the button actuated. The amount of information provided on the display is typically limited because such controllers are designed to be isolated from the internet or external networks for a variety of reasons, including security vulnerabilities and distance from local routers and network switches. Unfortunately, this lack of information is burdensome on installers and operators due to the need to determine the status of the devices and controller, and then to cross reference this status information with a lengthy user manual or other isolated reference source. Consequently, installation, operation, and customization of conventional controllers are difficult and limited.

Thus, even though various barrier operator controllers (including those with displays capable of providing basic information) are known in the art, all or almost all of them suffer from several drawbacks. Therefore, there remains a need for improved barrier operator controllers.

### SUMMARY OF THE INVENTION

The inventive subject matter is directed to various systems, controllers, and methods for improving the displaying of content for a controller for a barrier operator and its associated devices (e.g., locks, motors, sensors, cameras, etc.). Contemplated improvements are particularly desirable during installation, repair, or upgrading where significant amount of information (including drawings, diagrams, etc.) are often required for a device that is associated with the controller and where such information is not readily accessible or collocated with the device.

In one embodiment, a controller for a barrier operator is provided. The controller includes a control board communicatively coupled to a barrier operator and one or more devices and a display communicatively coupled to the control board. The controller further includes one or more data processors configured to receive device data of the device(s), generate natural-language content and encoded content in response to the device data, and display the natural-language content and the encoded content on the display.

In these and other embodiments, the data processor may also be configured to retrieve local informational content from a local database stored on the device data or the controller data and/or may be configured to display the local informational content on the display. The local informational content may be included as part of the natural-language content (e.g., may include instructions for the user to operate or modify the device or the controller).

In other embodiments, a system including the controller and a handheld device is contemplated. Typically, but not necessarily, the handheld device includes a mobile phone with camera, a tablet with camera, or a camera and a handheld display. The handheld device further includes one or more data processors configured to receive the encoded content via the camera, retrieve remote informational content from a remote database based on the encoded content, and display the remote informational content on the handheld display. For example, the remote informational content may include a user manual, an instructional image, an instructional video, or combinations thereof.

In yet another embodiment, a method for displaying content for the controller is also provided. The method includes receiving device data of the device and/or barrier operator and generating natural-language content and encoded content in response to the device and/or barrier operator data. The method further includes displaying the natural-language content and the encoded content on a display. The method further includes receiving the encoded content utilizing the camera by a user. The method further includes retrieving the remote informational content from the remote database based on the encoded content. The method further includes displaying the remote informational content on the handheld display.

Viewed from a different perspective, the inventors contemplate a controller for improving the ease of installation and use of controllers and devices (e.g., locks, motors, sensors, cameras, etc.) for barrier operators. In exemplary embodiments, the controller includes a display and a plurality of buttons associated with each of the devices and/or functionality of the controller. When a user actuates one of the buttons, the controller assesses the status of the particular device and, if relevant, the status or operation of the controller. The controller can then apply the device data and/or the controller data to local informational content from a local database. The display is then populated with natural-language content (e.g., alphanumeric text in the English-language) and encoded content (e.g., a QR code) based on the device data, the controller data, and the informational content. For example, the device data may include the state of the particular device, the controller data may include the history of the particular device, and the local informational content may include basic functionality instructions relating to the particular device or the controller.

If further information is desired regarding the particular device or the controller, the user can scan the QR code with a handheld device (e.g., smart phone) to apply the device data and the controller data encoded in the QR code to remote informational content from a remote database, such as from a standalone server through the internet. The remote informational content can be displayed as natural-language content on the display of the handheld device. The remote informational content may include a user manual, an instructional image, an instructional video, or combinations thereof.

This ability to retrieve local and remote informational contents relating to device data and controller data provides a user improved ease of use and access to relevant content for controllers that are not typically connected to the internet or other external networks. In particular, this system can provide up to date information regarding the devices and the controllers to the manufacturer, while at the same time providing up to date and high-quality guidance and instructions regarding installation and operation to installers and users. Therefore, the system provides improved the ease of use of the controller and the devices, and connectivity of devices during installation and operation.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The present invention will hereinafter be described in conjunction with the following drawing figures, wherein like numerals denote like elements.

FIG. 1 is a block diagram illustrating a system including a controller and a device; and

FIG. 2 is a schematic illustrating an embodiment of the controller of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

The inventors have discovered systems, controllers, and methods for improving the displaying of content for a controller for a barrier operator and its associated devices (e.g., locks, motors, sensors, cameras, barrier operator, etc.). In various embodiments, the controller includes a display and a plurality of buttons associated with each of the devices or functionality of the controller. When a user actuates one of the buttons, the controller assesses the status (and/or type or presence) of the device and, if relevant, the status of the controller. The controller can then apply the device data and the controller data to local informational content from a local database (typically stored in memory installed in the controller). The display is then populated with natural-language content (e.g., alphanumeric text in English-language) and encoded content (e.g., a QR code) based on the device data, the controller data, and the informational content. For example, the device data may include the state of the device, the controller data may include the history of the device, and the local informational content may include basic functionality instructions relating to the device or the controller.

Alternatively, or additionally, if further information is desired regarding the device or the controller, the user can scan the QR code with a handheld device (e.g., smart phone) to apply the device data and the controller data encoded in the QR code to remote informational content from a remote database, such as from a standalone server through the internet. The remote informational content can be displayed as natural-language content on the display of the handheld device. The remote informational content may include a user manual, an instructional image, an instructional video, or combinations thereof.

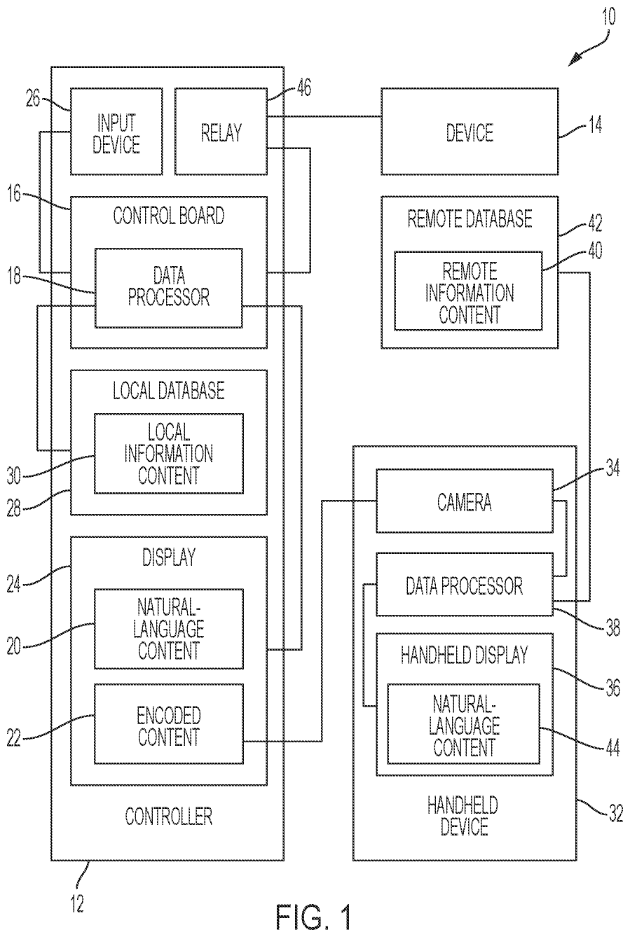

FIG. 1 is a block diagram illustrating a system 10 including a controller 12 and a device 14 (e.g., locks, motors, sensors, cameras, etc.) communicatively coupled to the controller 12. The system 10 may further include a barrier operator (not shown) and a movable gate (not shown) operatively coupled to the barrier operator. The controller 12 is electrically coupled to the barrier operator and, in particular, controls the barrier operator as well as the other devices 14. In various embodiments, the controller 12 is located away from the barrier operator (e.g., in a security booth).

The controller 12 includes a control board 16 communicatively coupled to the device 14, a display communicatively coupled to the control board 16, and one or more data processors 18. In various embodiments, the control board 16 and the data processor 18 perform computing operations and accesses electronic data stored in a memory module. It is to be appreciated that the data processor 18 may be associated with the control board 16 or separate from the control board 16. The control board 16 may be communicatively coupled to the various components of the controller 12 through a communication channel. The communication channel may be wired, wireless, or a combination thereof. Examples of wired communication channels include, but are not limited to, wires, fiber optics, and waveguides. Examples of wireless communication channels include, but are not limited to, Bluetooth, Wi-Fi, other radio frequency-based communication channels, and infrared. The control board 16 may be further configured to be communicatively coupled with the barrier operator, a vehicle or a receiver located distant from the controller 12. In various embodiments, the controller 12 is communicatively isolated from the internet or other external networks.

As noted above, it is contemplated that the data processor 18 is configured to receive device data of the device 14. The device data may be generated by the device 14, the control board 16, or any other component communicatively coupled to the device 14 (e.g., relays, processors, barrier operators, gates, etc.). The device 14 may include an electric motor, an actuator, hydraulics, pneumatics, mechanical locks, electromagnetic locks, or combinations thereof. However, it is to be appreciated that any device 14 can be utilized that is responsive to electrical current. In various embodiments, one or more of the devices 14 are associated with the barrier operator (e.g., motor, mechanical locks, actuators, etc.). In other embodiments, one or more of the devices 14 are associated with a movable gate (e.g., electromagnetic locks). Furthermore, suitable devices 14 also include a traffic light, a warning monitor, a tamper monitor, a lock, a loitering monitor, a gate position monitor, a camera, or combinations thereof. Moreover, the device 14 may include a sensor, such as a speed sensor, a position sensor, a safety sensor, or combinations thereof.

Therefore, contemplated device data may be any form of data that can provide information about the device 14, including, but not limited to, he presence or absence of the device, the type (e.g., model, serial number, etc.) of the device, the state of the device 14, instructions for installing or operating the device 14, functionality of the device 14, or the position of the device 14. In certain embodiments, the device 14 has a first state and a second state. In these and other embodiments, the device data indicates whether the device 14 is in the first state or the second state. For example, in embodiments when the device 14 is an electromagnetic lock, the first state may be when the lock is energized, and the second state may be when the lock is not energized. As another example, in embodiments when the device 14 is an actuator, the first state may be when the actuator is in a first position, and the second state may be when the actuator is in a second position.

The data processor 18 is further configured to generate natural-language content 20 and encoded content 22 in response to the device data and also configured to display the natural-language content 20 and the encoded content 22 on the display 24. In various embodiments, the natural-language content 20 and the encoded content 22 are shown on the same display, concurrently or at different points in time. However, it is to be appreciated that the natural-language content 20 and the encoded content 22 may be shown on separate displays, concurrently or at different points in time.

The natural-language content 20 may include the device data in a form that is understandable by a user such that the user can discern the device data. For example, in embodiments when the device 14 is an electromagnetic lock, the natural-language content 20 may indicate that the lock is energized or not energized depending on the state of the electromagnetic lock. As another example, in embodiments when the device 14 is an actuator, the natural-language content 20 may indicate that the actuator is in the first or the second position depending on the state of the actuator.

In contrast, the encoded content 22 may include a reference code that represents or defines the device data in a computer readable format that is not understandable by a user. The reference code may be an alphanumeric reference code or some form of symbology, such as a bar code or QR code. For example, in embodiments when the device 14 is an electromagnetic lock, the encoded content 22 may encode an indication that the lock is energized or not energized depending on the state of the electromagnetic lock in a computer readable format. As another example, in embodiments when the device 14 is an actuator, the encoded content 22 may indicate that the actuator is in the first or the second position depending on the state of the actuator in a computer readable format.

In various embodiments, the controller 12 includes an input device 26 communicatively coupled to the control board 16. The input device 26 includes an electrical switch or push button. However, it is to be appreciated that the input device 26 may be a touch sensitive device, a proximity sensor, a multifunction switching device, or combinations thereof. It is also to be appreciated that the input device 26 may be integrated into the display 24. The input device 26 may be configured to generate a query signal in response to activation of the input device 26, and the natural-language content 20 and the encoded content 22 may be displayed on the display 24 in response to the query signal.

It is also contemplated that the data processor 18 is further configured to receive controller data of the controller 12. The controller data may be generated by the controller 12, the control board 16, or any other component communicatively coupled to the controller 12 (e.g., relays, processors, barrier operators, gates, etc.). The controller data may be any form of data that can provide information about the controller 12, including, but not limited to, then presence of certain functionalities associated with the controller, type and number of devices connected to the controller, the status of the controller 12, instructions for installing or operating the controller 12, or functionality of the controller 12. In certain embodiments, the controller data includes a history of the device 14, a life cycle of controller 12, a serial number of the controller 12, a configuration of the controller 12, a configuration of the device 14, or combinations thereof. For example, in embodiments when the device 14 is an electromagnetic lock, the controller data may include a log of when the lock is energized or not energize to aid a user in assessing periods of access through the gate associated with the controller 12. As another example, the controller data may include the serial number of the controller 12 and length of operating time of the controller data 12 for diagnostic or tracking purposes.

Similar to the device data described above, the data processor 18 is further configured to generate natural-language content 20 and encoded content 22 in response to the controller data. As such, the data processor 18 is configured to display the natural-language content 20 and the encoded content 22 on the display 24 based on both the device data and the controller data. In various embodiments, the natural-language content 20 and the encoded content 22 based on both the device data and the controller data are shown on the same display, concurrently or at different points in time. However, it is to be appreciated that the natural-language content 20 and the encoded content 22 based on both the device data and the controller data may be shown on separate displays, concurrently or at different points in time.

Also similar to the device data described above, the natural-language content 20 may include the controller data in a form that is understandable by a user such that the user can discern the controller data. For example, in embodiments when the device 14 is an electromagnetic lock, the natural-language content 20 may indicate when the lock was last energized. As another example, the natural-language content 20 may show the serial number of the controller 12 and length of operating time of the controller data 12 for diagnostic or tracking purposes.

In contrast, the encoded content 22 may include a reference code that represents or defines the controller data in a computer readable format that is not understandable by a user. As described above, the reference code may be an alphanumeric reference code or some form of symbology, such as a bar code or QR code. For example, in embodiments when the device 14 is an electromagnetic lock, the encoded content 22 may encode when the lock was last energized in a computer readable format. As another example, in embodiments when the device 14 is an actuator, the encoded content 22 may encode the serial number of the controller 12 and length of operating time of the controller data for diagnostic or tracking purposes in a computer readable format.

In certain embodiments, the data processor 18 is further configured to retrieve local informational content 28 from a local database 30 based on the device data or the controller data and also configured to display the local informational content 28 on the display 24. The local informational content 28 may be included as part of the natural-language content 20. The local database 30 may be included in a storage device communicatively coupled to the control board 16. The local informational content 28 may include instructions for the user to operate or modify the device 14 or the controller 12.

Referring back to the system 10, the system 10 further includes a handheld device 32. The handheld device 32 may be a smart phone or a tablet. However, it is to be appreciated that the handheld device 32 may be any device capable of receiving the encoded content 22. The handheld device 32 includes a camera 34, a handheld display 36, and one or more data processors 38. The data processor 38 is configured to receive the encoded content 22 utilizing the camera 34, retrieve remote informational content 40 from a remote database 42 based on the encoded content 22, and display the remote informational content 40 on the handheld display 36. In various embodiments, the remote informational content 40 is displayed as natural-language content 44 on the handheld display 36. However, the displayed content may also include symbolic content (e.g., wiring or block diagram), pictorial content, and/or video content. The remote database 42 may be included in a storage device communicatively coupled to the handheld device 32. For example, the handheld device 32 may include a storage device including the remote database 42. As another example, the handheld device 32 and the remote database 42 may be communicatively coupled via the internet. The remote informational content 40 may include a user manual, an instructional image, an instructional video, or combinations thereof.

In some exemplary embodiments, a user may press the input device 26 (e.g., a button) and then the controller 12 can display natural-language content 20 (e.g., local information content 28 for the device 14 and the controller 12) and encoded content 22 (e.g., a QR code encoding the status or repair or replacement instructions of the device 14 and the controller 12) on the display 24 of the controller 12. If the user desires more information regarding the device 14 or the controller 12, the user can use the handheld device 32. In particular, the user can scan the encoded content 22 (e.g., the QR code) with the camera 34 of the handheld device 32 (e.g., a smart phone) to access the remote informational content 40 (e.g., instructional videos) of the remote database 42 (e.g., off-site server). The remote informational content 40 (e.g., instructional videos) can then be displayed on the handheld display 36 of the handheld device 32 (e.g., a smart phone).

Referring back to the controller 12, in some embodiments, the controller 12 includes a relay 46 electrically coupled to the device 14 and communicatively coupled to the control board 16. The relay 46 may be configured to generate a status signal in response to the device 14 being in the first state or the second state. In these and other embodiments, the control board 16 is configured to generate the device data in response to the status signal. It is to be appreciated that the relay 46 may be any device capable of closing and opening an electrical circuit electronically, electromechanically, or a combination thereof.

In these and other embodiments, the relay 46 is electrically coupled to the device 14. The relay 46 may be configured to provide any amount of electrical current to the device 14. Thus, the relay 46 may be configured as an electromechanical relay or a software relay. In various embodiments, the system 10 includes a plurality of devices 14 coupled to a plurality of relays 46, respectively (e.g., one relay 46 for each device 14).

The controller 12 may further include an energy source (not shown) configured to provide an electrical current. The energy source may be electrically coupled to the control board 16 such that the control board 16 is configured to generate a base signal in response to the energy current. The energy source may be an AC energy source, a DC energy source (e.g., a battery or solar panel), or a combination thereof. As described in greater detail below, the energy source may be different than the energy source utilized to energize the barrier operator.

The display 24 and the handheld display 36 may be any devices capable of displaying content to a user. Examples of suitable displays include, but are not limited to, liquid crystal displays, light-emitting diode displays, electrophoretic displays, dot-matrix displays, or combinations thereof. It is to be appreciated that the display 24 and the handheld display 36 can be same type of display or different.

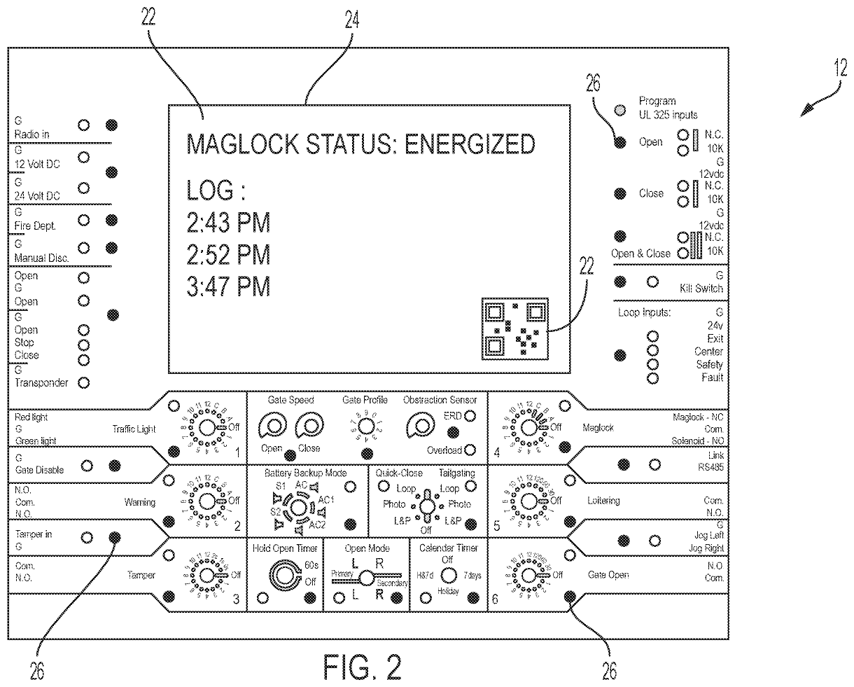

FIG. 2 is a schematic illustrating an embodiment of the controller of FIG. 1. In these and other embodiments, the controller 12 is communicatively coupled to several devices (e.g., a traffic light, warning monitor, a tamper monitor, a lock, loitering monitor, gate position monitor) and includes several input devices 26 (e.g., buttons) with some of the input devices 26 associated with one of the several devices. Other input devices 26 may be associated with status or functionality of the controller (e.g., fault history, timers, setup/programming, language selection, etc.). Some of the input devices 26 are communicatively coupled to the devices through their relays and the control board. During operation of the controller 12, a user can press the desired input device(s) 26 to generate a query signal which leads to the generation of the status signal in response to the query signal. The processor then receives at least one of the device data or the controller data in response to the status signal, applies at least one of the device data and the controller data to the local informational content of the local database, and generates the natural-language content and the encoded content in response to at least one of the device data, the controller data, and the local informational content. The natural-language content 22 and the encoded content 22 are then displayed on the display 24 for review by the user and for scanning by the handheld device, respectively.

For example, the input device associated with a “Maglock” device may generate a query signal in response to being pressed. The query signal is then received by the control board and a status signal is generated by the relay associated with the “Maglock” device in response to the query signal. The processor then receives the status of the “Maglock” device (device data) and the history of the “Maglock” device (controller data) in response to the status signal. The processor applies the status and history of the “Maglock” device to the local informational content of the local database and generates an alphanumeric message in the English-language (natural-language content) regarding the status and history of the “Maglock” device. The processor also generate a QR code (encoded content) encoding the status and history of the “Maglock” device. The alphanumeric message in the English-language and the QR code are then displayed on the display 24 for review by the user and for scanning by the user's smart phone (handheld device), respectively. If the user desires more information regarding the status and history of the “Maglock” device (e.g., troubleshooting guidance, calibration instructions, repair or replacement information), the user can scan the QR code with the smart phone and receive, for example, a reference to a relevant portion of the user manual and a link to a video on the smart phone's display (handheld display 36).

Referring back to the system 10 of FIG. 1, the barrier operator may be any type of movable barrier operator suitable to actuate, operate, or otherwise control access via the movable gate. Thus, a barrier operator may be a swing barrier operator that swings open, a sliding barrier operator that moves a gate on a track, a locking mechanism that locks and unlocks a door to an entry, or any other type of operator suitable for controlling the type of movable gate that may be implemented with system 10. Typically, the barrier operator may include a motor. For example, in a typical residential access control system having a dual swing gate arrangement where the gates pivot about respective axes to so open or close access into out egress out of a neighborhood, each gate may have the barrier operator that is mechanically coupled to the movable gate to so drive motion of the respective gate. The controller 12 may be electrically coupled to the barrier operators to control operation of the motor in each of the barrier operators. In various embodiments, the controller 12 manages the barrier operator and provides programmed operation by executing a sequence of commands to the motor of the barrier operator via a power amplifier to control the motor.

In certain embodiments, the motor is a DC motor, such as a 24 Volt DC permanent magnet brush-type motor. The power amplifier is electrically coupled to the controller 12 to deliver power to the motor. The power amplifier is adapted to interface with an energy source, such as an AC (alternating current) electrical outlet via a power cord. During operation, the power amplifier receives electrical current from its power source and control signals from the controller 12, and outputs electrical current to the motor to energize the motor of the barrier operator. In such an embodiment, the power amplifier converts the AC electrical current to a DC electrical current. Alternatively, its power source could be a DC power source such as a battery.

A method for displaying content for the controller 12 for the barrier operator is also provided. The method includes receiving device data of the device 14 and generating natural-language content 20 and encoded content 22 in response to the device data. The method further includes displaying the natural-language content 20 and the encoded content 22 on a display 24. The method further includes receiving the encoded content 22 utilizing the camera 34 by a user. The method further includes retrieving the remote informational content 40 from the remote database 42 based on the encoded content 22. The method further includes displaying the remote informational content 40 on the handheld display 36.

In various embodiments, the method further includes receiving the controller data of the controller 12 and generating the natural-language content 20 and the encoded content 22 in response to the controller data. In these and other embodiments, the method further includes retrieving the local informational content 28 from the local database 30 based on the device data or the controller data and displaying the local informational content 28 on the display 24.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Moreover, the term “electronically coupled” includes direct and indirect coupling, either through a wired conductive path or a wireless (e.g., optical, electromagnetic, etc.) communication path.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A controller for a barrier operator, comprising:
a control board communicatively coupled to the barrier operator and a device;
a display communicatively coupled to the control board; and
one or more data processors configured to:
receive device data of the device and optionally the barrier operator,
generate natural-language content and encoded content in response to the device data, and
display the natural-language content and the encoded content on the display.

2. The controller of claim 1 further comprising an input device communicatively coupled to the control board, wherein the input device is configured to generate a query signal in response to activation of the input device, and wherein the natural-language content and the encoded content are displayed on the display in response to the query signal.

3. The controller of claim 2, wherein the input device comprises an electrical switch or push button.

4. The controller of claim 1, wherein the encoded content comprises a reference code or a QR code.

5. The controller of claim 1, wherein the device has first state and a second state, and the device data indicates whether the device is in the first state or the second state, and optionally further comprising a relay that is electrically coupled to the device and communicatively coupled to the control board, wherein the relay is configured to generate a status signal in response to the device being in the first state or the second state, and wherein the control board is configured to generate the device data in response to the status signal.

6. The controller of claim 1, wherein the one or more data processors are further configured to receive controller data of the controller, and to generate the natural-language content and the encoded content in response to the controller data.

7. The controller of claim 6, wherein the controller data comprises a history of the device, a life cycle of controller, a serial number of the controller, a configuration of the controller, a configuration of the device, or combinations thereof.

8. The controller of claim 1, wherein the one or more data processors are further configured to retrieve local informational content from a local database based on the device data or the controller data, and to display the local informational content on the display, wherein the local information content comprises instructions to operate or modify the device or the controller.

9. A system for a barrier operator, comprising:
a controller comprising;
a control board communicatively coupled to the barrier operator and a device;
a display communicatively coupled to the control board; and
one or more data processors configured to:
receive device data of the device and optionally the barrier operator,
generate natural-language content and encoded content in response to the device data, and
display the natural-language content and the encoded content on the display;
a handheld device comprising;
a camera;
a handheld display; and
one or more data processors configured to;
receive the encoded content utilizing the camera,
retrieve remote informational content from a remote database based on the encoded content, and
display the remote informational content on the handheld display.

10. The system of claim 9, wherein the handheld device is a smart phone or tablet, and/or wherein the remote informational content comprises a user manual, an instructional image, an instructional video, or combinations thereof.

11. The system of claim 9, wherein the one or more data processors are further configured to receive controller data of the controller generated by the control board, and to generate the natural-language content and the encoded content in response to the controller data, wherein the controller data comprises a history of the device, a life cycle of controller, a serial number of the controller, a configuration of the controller, a configuration of the device, or combinations thereof.

12. The system of claim 9, wherein the one or more data processors are further configured to retrieve local informational content from a local database based on the device data or the controller data, and to display the local informational content on the display, and optionally wherein the local informational content comprises instructions to operate or modify the device or the controller.

13. The system of claim 9, wherein the controller further comprises an input device communicatively coupled to the control board, wherein the input device is configured to generate a query signal in response to activation of the input device, and wherein the natural-language content and the encoded content are displayed on the display in response to the query signal.

14. The system of claim 9, wherein the encoded content comprises a reference code or a QR code.

15. A method for displaying content for a controller for a barrier operator, the method comprising:
receiving, by one or more data processors of the controller device data of a device;
generating natural-language content and encoded content in response to the device data;
displaying the natural-language content and the encoded content on a display;
receiving the encoded content utilizing a camera of a handheld device by a user;
retrieving remote informational content from a remote database, wherein the remote informational content is based on the encoded content; and
displaying the remote informational content on a handheld display of the handheld device.

16. The method of claim 15, wherein the remote informational content comprises a user manual, an instructional image, an instructional video, or combinations thereof.

17. The method of claim 15 further comprising receiving controller data of the controller, and generating the natural-language content and the encoded content in response to the controller data.

18. The method of claim 17, wherein the controller data comprises a history of the device, a life cycle of controller, a serial number of the controller, a configuration of the controller, a configuration of the device, or combinations thereof.

19. The method of claim 15 further comprising retrieving local informational content from a local database based on the device data or the controller data, and displaying the local informational content on the display.

20. The method of claim 19, wherein the local informational content comprises instructions to operate or modify the device or the controller.
